(19) United States
(12) Patent Application Publication
(10) Pub. No.: US 2023/0153763 A1
(43) Pub. Date: May 18, 2023

(54) MEETING SUPPORT SYSTEM, MEETING SUPPORT METHOD, AND RECORDING MEDIUM RECORDING MEETING SUPPORT PROGRAM

(71) Applicant: SHARP KABUSHIKI KAISHA, Osaka (JP)

(72) Inventor: KAZUO MAKIJIMA, Osaka (JP)

(21) Appl. No.: 17/983,247

(22) Filed: Nov. 8, 2022

(30) Foreign Application Priority Data
Nov. 12, 2021 (JP) 2021-184571

(51) Int. Cl. G06Q 10/10

(52) U.S. Cl. CPC G06Q 10/1095

(57) ABSTRACT

A meeting support system includes a first acquisition processor which acquires location information of a first user, a second acquisition processor which acquires meeting schedule information of the first user, a first determination processor which determines whether a first meeting to be held in a first meeting room corresponding to the location information is registered in the meeting schedule information or not, a second determination processor which determines whether the first user is registered in the meeting schedule information as a participant of the first meeting or not, and a notification processor which notifies participants of a second meeting currently being held in the first meeting room of predetermined information, when the first meeting is registered in the meeting schedule information and the first user is registered in the meeting schedule information as a participant of the first meeting.

### INCORPORATION BY REFERENCE

This application is based upon and claims the benefit of priority from the corresponding Japanese Patent Application No. 2021-184571 filed on Nov. 12, 2021, the entire contents of which are incorporated herein by reference.

### BACKGROUND

The present disclosure relates to a meeting support system, a meeting support method, and a recording medium recording a meeting support program.

Conventionally, such a system is known that supports meetings on the basis of meeting schedule information (schedule information) and the like. For example, there are known systems that calculate expected travel time to a destination and notify users of reminders based on the calculated expected travel time and notification time set in a calendar. According to this system, meeting participants can be notified in time of start of the meeting, for example.

Here, if a previous meeting is being held in a meeting room to be used for the meeting and the meeting does not end at the scheduled time, such a situation may arise that the meeting participants of the next meeting cannot start the meeting at the scheduled time, for example. Although the conventional art can notify meeting participants of a meeting schedule (reminder), a problem arises when the start of the meeting is delayed if the previous meeting does not end at the scheduled time.

### SUMMARY

An object of the present disclosure is to provide a meeting support system, a meeting support method, and a recording medium recording a meeting support program that can start a meeting at a scheduled time.

A meeting support system according to one aspect of the present disclosure is a meeting support system which supports a meeting in which a plurality of users participate, including a first acquisition processor which acquires location information of a first user, a second acquisition processor which acquires meeting schedule information of the first user, a first determination processor which determines whether a first meeting to be held in a first meeting room corresponding to the location information is registered in the meeting schedule information or not, a second determination processor which determines whether the first user is registered in the meeting schedule information as a participant of the first meeting or not, and a notification processor which notifies participants of a second meeting currently being held in the first meeting room of predetermined information when the first meeting is registered in the meeting schedule information and the first user is registered in the meeting schedule information as a participant of the first meeting.

A meeting support method according to another aspect of the present disclosure is a meeting support method for supporting a meeting in which a plurality of users participate, which causes one or more processors to execute first acquiring of acquiring location information of a first user, second acquiring of acquiring meeting schedule information of the first user, first determining of determining whether a first meeting to be held in a first meeting room corresponding to the location information is registered in the meeting schedule information or not, second determining of determining whether the first user is registered in the meeting schedule information as a participant of the first meeting, and notifying of notifying the participants of a second meeting currently being held in the first meeting room of predetermined information when the first meeting is registered in the meeting schedule information and the first user is registered in the meeting schedule information as a participant of the first meeting.

A recording medium according to another aspect of the present disclosure is a recording medium recording a meeting support program for supporting a meeting in which a plurality of users participate, which causes one or more processors to execute first acquiring of acquiring location information of a first user, second acquiring of acquiring meeting schedule information of the first user, first determining of determining whether a first meeting to be held in a first meeting room corresponding to the location information is registered in the meeting schedule information or not, second determining of determining whether the first user is registered in the meeting schedule information as a participant of the first meeting or not, and notifying of notifying the participants of a second meeting currently being held in the first meeting room of predetermined information when the first meeting is registered in the meeting schedule information and the first user is registered in the meeting schedule information as a participant of the first meeting.

According to the present disclosure, a meeting support system, a meeting support method, and a recording medium recording a meeting support program that are capable of starting a meeting at a scheduled time can be provided.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic diagram illustrating a schematic configuration of a meeting support system according to an embodiment of the present disclosure.

FIG. 2 is a functional block diagram illustrating a configuration of the meeting support system according to the embodiment of the present disclosure.

FIG. 3 is a diagram illustrating an example of a meeting-schedule information management table according to the embodiment of the present disclosure.

FIG. 4 is a diagram illustrating an example of a meeting-room information management table according to the embodiment of the present disclosure.

FIG. 5 is a diagram illustrating an example of a user information management table according to the embodiment of the present disclosure.

FIG. 6 is a diagram illustrating an example of a notification displayed on a user terminal according to the embodiment of the present disclosure.

FIG. 7 is a diagram illustrating an example of a notification displayed on a display according to the embodiment of the present disclosure.

FIG. 8 is a diagram illustrating an example of a notification displayed on the user terminal according to the embodiment of the present disclosure.

FIG. 9 is a flowchart for explaining an example of a procedure of meeting support processing executed in the meeting support system according to the embodiment of the present disclosure.

FIG. 10 is a schematic diagram illustrating a schematic configuration of the meeting support system according to the embodiment of the present disclosure.

FIG. 11 is a diagram illustrating an example of a notification displayed on the user terminal according to the embodiment of the present disclosure.

FIG. 12 is a diagram illustrating an example of a notification displayed on the display according to the embodiment of the present disclosure.

FIG. 13 is a diagram illustrating an example of the notification displayed on the user terminal according to the embodiment of the present disclosure.

FIG. 14 is a flowchart for explaining an example of a procedure of the meeting support processing executed in the meeting support system according to the embodiment of the present disclosure.

FIG. 15 is a diagram illustrating an example of the notification displayed on the display according to the embodiment of the present disclosure.

FIG. 16 is a diagram illustrating an example of the notification displayed on the user terminal according to the embodiment of the present disclosure.

FIG. 17 is a diagram illustrating an example of the notification displayed on the user terminal according to the embodiment of the present disclosure.

FIG. 18 is a diagram illustrating an example of the notification displayed on the user terminal according to the embodiment of the present disclosure.

FIG. 19 is a diagram illustrating an example of the notification displayed on the user terminal according to the embodiment of the present disclosure.

FIG. 20 is a diagram illustrating an example of the notification displayed on the display according to the embodiment of the present disclosure.

### DETAILED DESCRIPTION

Hereinafter, an embodiment of the present disclosure will be described with reference to the accompanying drawings. Note that the following embodiment is merely an example that embodies the present disclosure, and is not intended to limit the technical scope of the present disclosure.

A meeting support system according to the present disclosure is applicable to, for example, a meeting in which a plurality of users participate at one or a plurality of locations (meeting rooms and the like). The meeting support system according to this embodiment is an example of the meeting support system of the present disclosure. For example, in the meeting support system according to this embodiment, user terminals (smartphones, for example) used by users participating in the meeting, displays showing meeting screens such as materials used in the meeting and the like are disposed in the meeting room. In addition, communication tags (NFC or the like) capable of communicating with the user terminals are installed near the entrance/exit of the meeting room. In addition, the meeting support system includes a management server that manages information on meetings, meeting rooms, devices used for the meetings and the like.

Meeting Support System 100

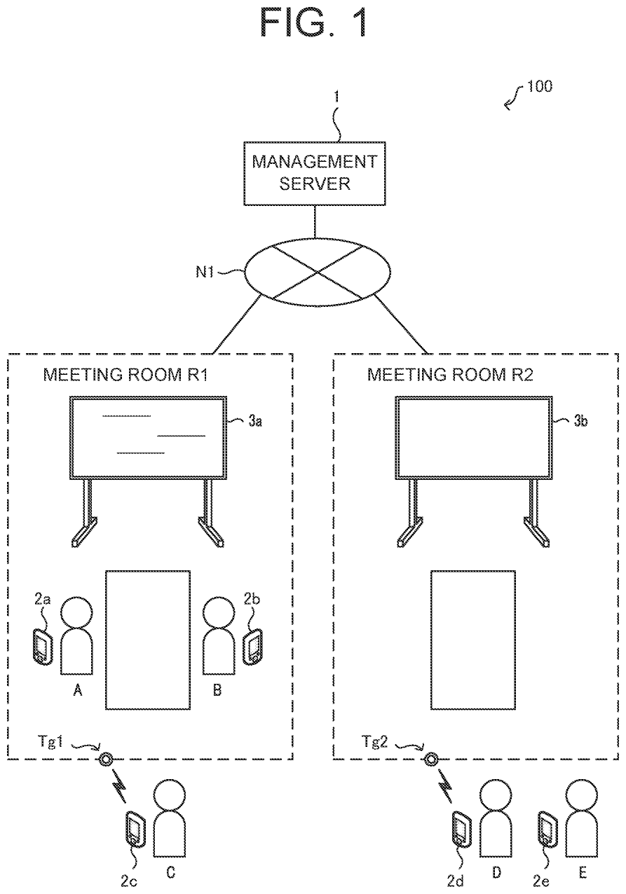

FIG. 1 is a diagram illustrating a schematic configuration of a meeting support system 100 according to an embodiment of the present disclosure. The meeting support system 100 includes a management server 1, a user terminal 2, and a display 3. The meeting support system 100 is a system that supports meetings in which a plurality of users participate.

FIG. 1 shows a meeting room R1 and a meeting room R2. Here, a state in which users A and B are having a meeting in the meeting room R1 is shown. In the meeting room R1, two user terminals 2a, 2b held by the users A, B, respectively, and a display 3a (an example of a first display of the present disclosure) capable of displaying meeting materials and the like are disposed. Also, a communication tag Tg1 is installed near the entrance/exit of the meeting room R1.

Moreover, outside the meeting room R1 (in front of the meeting room R1), a user C, who is a participant of a next meeting, is waiting, holding a user terminal 2c. Also, outside the meeting room R2 (in front of the meeting room R2), users D, E, who will have a meeting with the user C, holding the user terminals 2d, 2e, respectively, are waiting. A display 3b (an example of a second display of the present disclosure) capable of displaying meeting materials and the like is disposed in the meeting room R2. Also, a communication tag Tg2 is installed near the entrance/exit of the meeting room R2.

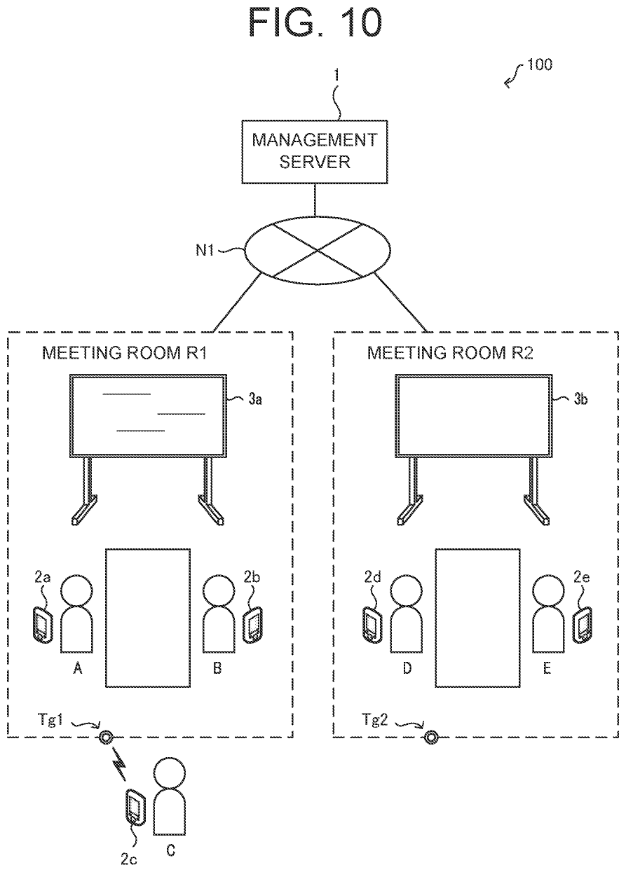

Each user using the meeting room enters the meeting room by holding his/her user terminal 2 over the communication tag Tg. The user terminal 2 transmits predetermined information corresponding to its own location information (identification information (tag ID) of the communication tag Tg or the like, for example) to the management server 1 by communicating with the communication tag Tg. In the example in FIG. 1, if the meeting room R2 is vacant, the users D, E can also enter the meeting room R2 by holding their user terminals 2d, 2e over the communication tag Tg2 (see FIG. 10). The communication tag Tg is an example of a target to be read in the present disclosure.

A meeting M2, in which users C, D, E participate, is an online meeting held by connecting the meeting rooms R1 and R2. The meeting support system 100 enables online meetings in the meeting room R1 and the meeting room R2 by executing a meeting support application installed in each of the user terminals 2c, 2d, 2e. The meeting support system 100 has a microphone-speaker device, a camera and the like connected to the meeting rooms R1, R2 and is configured to enable bidirectional communication of voice and camera images. The microphone-speaker device and the camera may be built into the user terminal 2.

A meeting held by the users A, B in the one meeting room R1 can also be held online in the meeting room R1 by connecting the user terminals 2a, 2b, the display 3a and the like and executing the meeting support application installed in each of the user terminals 2a, 2b.

The management server 1 is configured by, for example, one or a plurality of server devices (cloud servers, for example). The user terminal 2 is a user's terminal device that a user participating in the meeting brings into the meeting room, such as a smartphone, a personal computer (PC) or the like.

The management server 1 and the user terminal 2 are connected to each other via a network N1. The network N1 is a communication network such as the Internet, a LAN, a WAN, and a public telephone line. The user terminal 2 and meeting room equipment (the display 3, the microphone-speaker device, the camera and the like) may be connected by a wired LAN or a wireless LAN.

Management Server 1

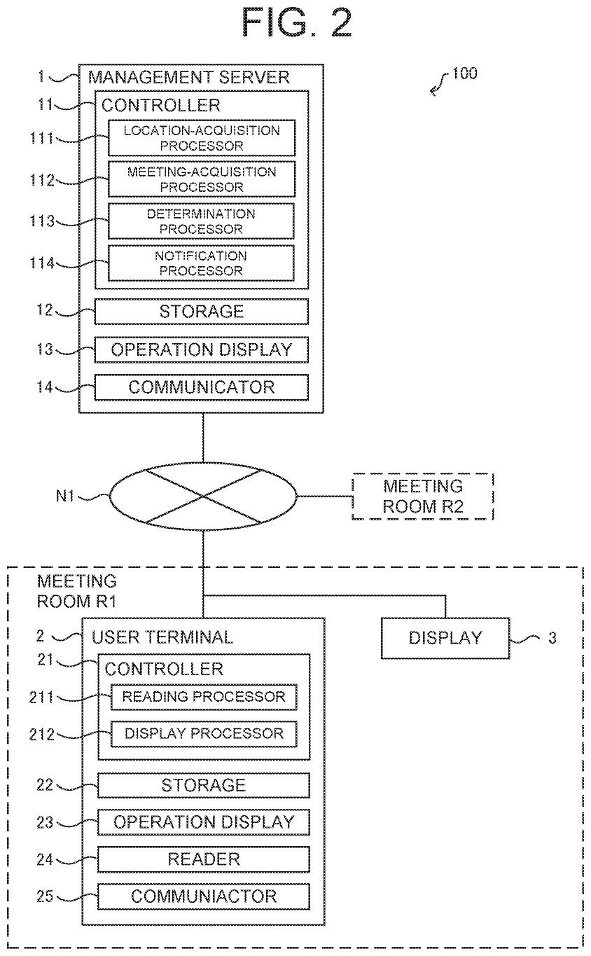

As shown in FIG. 2, the management server 1 includes a controller 11, a storage 12, an operation display 13, a communicator 14 and the like. The management server 1 may be one or a plurality of virtual servers (cloud servers) or may be one or a plurality of physical servers.

The communicator 14 is a communicator which connects the management server 1 to the network N1 in a wired or wireless manner and executes data communication according to a predetermined communication protocol with other devices (the user terminal 2, for example) via the network N1.

The operation display 13 is a user interface including a display such as a liquid crystal display or an organic EL display, which displays various types of information and an operation acceptor such as a mouse, a keyboard, or a touch panel, which receives an operation. The operation display 13 receives, for example, an operation of an administrator of the management server 1.

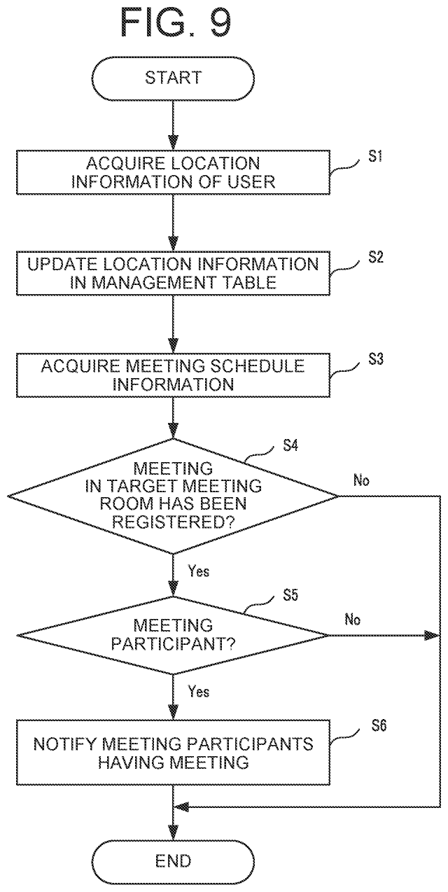

The storage 12 is a non-volatile storage such as an HDD (Hard Disk Drive), an SSD (Solid State Drive), or a flash memory, which stores various types of information. The storage 12 stores control programs such as a meeting support program to cause the controller 11 to execute the meeting support processing (see FIG. 9 and the like) described below. For example, the meeting support program is recorded in a computer-readable recording medium such as a CD or a DVD in a non-transitory manner, is read by a reader (not shown) such as a CD drive or a DVD drive included in the management server 1, and is stored in the storage 12. The meeting support program may be distributed from a cloud server and stored in the storage 12.

In addition, the storage 12 stores management tables including various types of information for supporting meetings. Specifically, the storage 12 stores data such as a meeting-schedule information management table T1 that manages meeting information related to meeting schedule (booking), a meeting-room information management table T2 that manages meeting room information related to equipment installed in meeting rooms, a user-information management table T3 that manages user information related to users and the like.

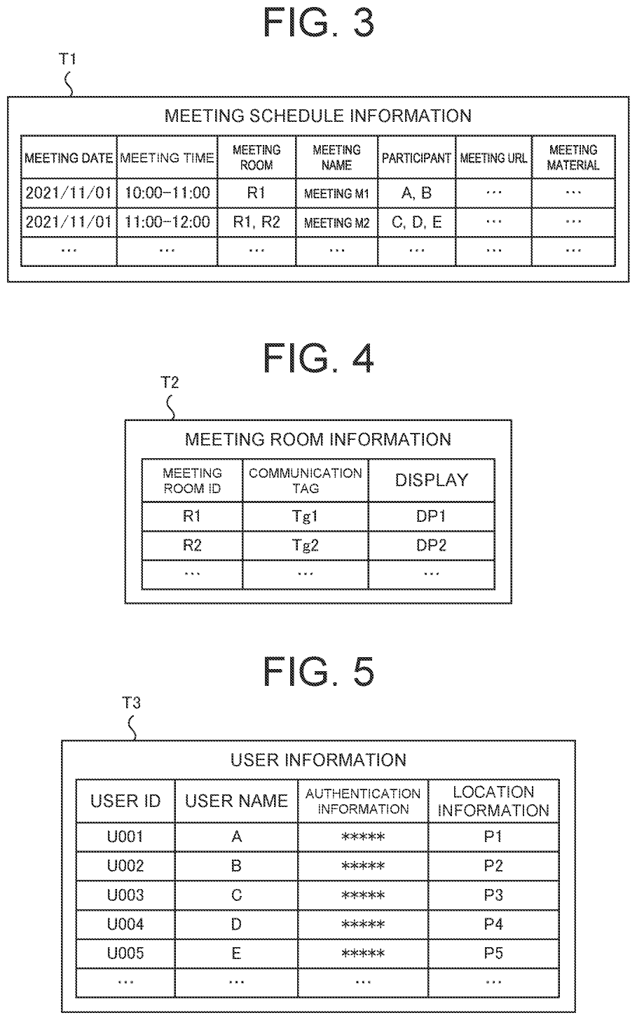

FIG. 3 is a diagram illustrating an example of the meeting-schedule information management table T1. In the meeting-schedule information management table T1, meeting information in which a meeting date, a meeting time, a meeting room, a meeting name, participants, a meeting URL, meeting materials and the like are associated with each other for each meeting is registered. The meeting room is information (meeting room name, meeting room ID) indicating a meeting room where a meeting is held. The participants are information (user name, user ID and the like) indicating the users participating in the meeting. The meeting URL is access information (connection information) for connecting when an online meeting is started. For example, the meeting support application accesses the meeting URL so as to start an online meeting application (a general-purpose meeting application and the like) corresponding to the meeting URL and to connect to a destination ID (meeting ID). The meeting materials are the materials used for the meeting. For example, when the user (person who makes the reservation) who registers the meeting information registers the meeting information including each of the information described above in his/her own user terminal 2 when it is determined that the meeting will be held. The controller 11 registers the aforementioned meeting information in the meeting-schedule information management table T1 in accordance with the registration operation of a person who made the reservation. A function for managing the meeting schedule information including the aforementioned meeting information does not have to be included in the management server 1. For example, when an external server different from the management server 1 provides a service (a calendar service, for example) to manage the meeting schedule information, the management server 1 may access the external server, refer to the meeting schedule information, and acquire the meeting information corresponding to the user ID.

FIG. 4 is a diagram illustrating an example of the meeting-room information management table T2. In the meeting-room information management table T2, meeting room information in which information such as communication tags, displays and the like is associated with each other is registered for each meeting room. The communication tag is information (tag name, tag ID and the like) that indicates the communication tag Tg installed near the entrance/exit of the meeting room. The display is identification information of the display 3 installed in the meeting room. “DP1” represents a display 3a in the meeting room R1, and “DP2” represents a display 3b in the meeting room R2. In the meeting-room information management table T2, the meeting room information for each meeting room is registered in advance by the administrator or the like through a registration operation.

FIG. 5 is a diagram illustrating an example of the user-information management table T3. In the user-information management table T3, information such as user information such as a user ID, a user name, authentication information, location information and the like is associated with each other and registered for each user. The user ID and the authentication information (password or the like) are used as login information at login to the meeting support application. The location information is information indicating the location of the user (user terminal 2). The location information is location information identified on the basis of information transmitted from the user terminal 2, and is updated in accordance with the location of the user terminal 2. In the user-information management table T3, the user information (user ID, user name, and authentication information) for each user is registered in advance by the user's registration operation, and the location information according to the location of the user terminal 2 is registered and updated. The information of the user terminal 2 (terminal ID) used by the user may be registered in the user-information management table T3.

Some or all of the meeting-schedule information management table T1, the meeting-room information management table T2, and the user-information management table T3 may be stored in a server accessible from the management server 1.

The controller 11 has control devices, such as a CPU, a ROM, and a RAM. The CPU is a processor that executes various types of arithmetic processing. The ROM stores in advance control programs such as a BIOS and an OS that cause the CPU to execute various types of processing. The RAM stores various types of information and is used as a temporary storage memory (work area) for the various types of processing executed by the CPU. And the controller 11 controls the management server 1 by causing the CPU to execute various types of control programs stored in advance in the ROM or the storage 12.

Specifically, the controller 11 includes various types of processors such as a location acquisition processor 111, a meeting acquisition processor 112, a determination processor 113, a notification processor 114 and the like. The controller 11 executes various types of processing in accordance with the meeting support program and functions as the various types of processors described above. Moreover, some or all of the processors included in the controller 11 may be configured by an electronic circuit. The meeting support program may be a program that causes a plurality of processors to function as various types of processors described above.

In the following, the meeting schedule information registered in the meeting-schedule information management table T1 shown in FIG. 3 will be explained by citing specific examples. FIG. 1 shows a state in which users A, B are having a meeting (“meeting M1”) in a meeting room R1 at the current time (“10:55”), and a user C, who will participate in the next meeting M2 (meeting start time “11:00”) is waiting in front of the meeting room R1.

The location acquisition processor 111 acquires location information of the users. Specifically, the location acquisition processor 111 acquires location information of the user when the user terminal 2 held by the user communicates with the communication tag Tg installed near the entrance/exit of the meeting room. For example, in the example shown in FIG. 1, when the user C (an example of the first user of the present disclosure) comes to the meeting room R1 to participate in the meeting M2 and holds the user terminal 2c over the communication tag Tg1, the user terminal 2c sends identification information of the user terminal 2c (terminal ID) and identification information of the communication tag Tg1 (tag ID) to the management server 1. The location acquisition processor 111 acquires the identification information of the user terminal 2c and the identification information of the communication tag Tg1 from the user terminal 2c and then, acquires the location information corresponding to the identification information of the communication tag Tg1. For example, the location acquisition processor 111 refers to the meeting-room information management table T2 and acquires information of a spot where the communication tag Tg1 is installed (meeting room ID of meeting room R1). The location acquisition processor 111 registers the acquired location information in the user-information management table T3 (see FIG. 5). Here, as the location information of user C (“P3” in FIG. 5), the installation spot of the communication tag Tg1 (meeting room R1, for example) is registered. The location acquisition processor 111 is an example of a first acquisition processor of the present disclosure.

The meeting acquisition processor 112 acquires the user's meeting schedule information. Specifically, the meeting acquisition processor 112 refers to the meeting-schedule information management table T1 (see FIG. 3) and acquires meeting schedule information of the meeting in which the user will participate. For example, when the user C holds the user terminal 2c over the communication tag Tg1 in the meeting room R1, the meeting acquisition processor 112 identifies the user on the basis of the identification information of the user terminal 2c acquired from the user terminal 2c and acquires the meeting schedule information of the meeting in which the identified user is registered as a participant. Here, the meeting acquisition processor 112 acquires the meeting schedule information of the meeting M2 in which the user C will participate. The meeting acquisition processor 112 is an example of a second acquisition processor of the present disclosure.

The determination processor 113 determines whether a meeting to be held in the meeting room corresponding to the location information acquired by the location acquisition processor 111 is registered in the meeting schedule information acquired by the meeting acquisition processor 112 or not. For example, the determination processor 113 determines whether the meeting to be held in the meeting room R1 corresponding to the location information of the user C acquired by the location acquisition processor 111 (the location in front of the meeting room R1, for example) is registered in the meeting schedule information of the meeting acquired by the meeting acquisition processor 112 and in which the user C will participate or not. Here, the determination processor 113 determines that the meeting M2 to be held in the meeting room R1 corresponding to the location information is registered in the meeting schedule information. The determination processor 113 is an example of the first determination processor in the present disclosure.

The determination processor 113 also determines whether the user is registered in the meeting schedule information as a participant of the meeting or not. For example, the determination processor 113 determines whether the user C is registered in the meeting schedule information as a participant of the meeting M2 or not. Here, the determination processor 113 determines that the user C is registered in the meeting schedule information as a participant of the meeting M2. The determination processor 113 is an example of a second determination processor in the present disclosure.

When the meeting is registered in the meeting schedule information and the user is registered in the meeting schedule information as a participant of the meeting, the notification processor 114 notifies the participants of the meeting currently being held in the meeting room of predetermined information. Here, since the meeting M1 is being held in the meeting room R1 (see FIG. 1), the notification processor 114 notifies the participants of the meeting M1, that is, the users A, B, of the predetermined information.

Specifically, the notification processor 114 causes information indicating that the user C, a participant of the next meeting, is waiting outside the meeting room R1 to be displayed at least on any one of the user terminals 2a, 2b of the users A, B, and the display 3a installed in the meeting room R1. The notification processor 114 also causes information on end time of the meeting M1 of the users A, B to be displayed at least on any one of the user terminals 2a, 2b of the users A, B and the display 3a.

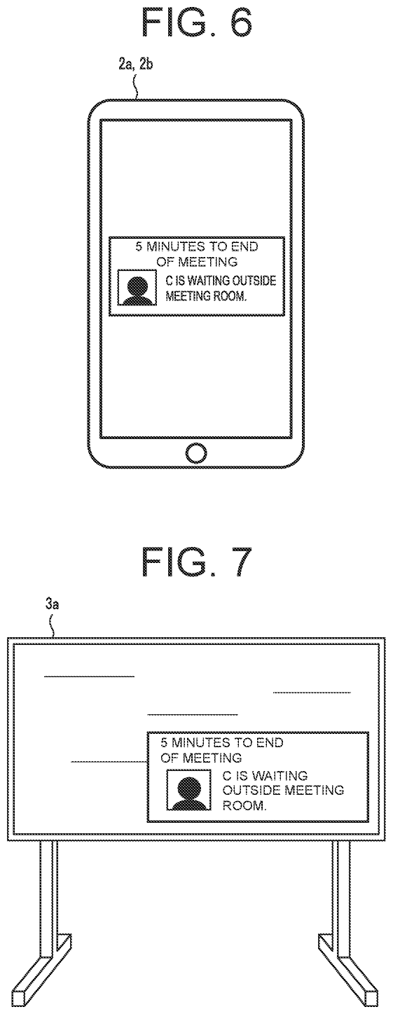

FIG. 6 shows an example of a display screen of the user terminals 2a, 2b, and FIG. 7 shows an example of a display screen of the display 3a. The notification processor 114 causes remaining time to the end of the meeting M1 (“5 minutes”, here), a message indicating that the user C is waiting outside the meeting room R1 or the like to be displayed at least on any one of the user terminals 2a, 2b, and the display 3a.

The notification processor 114 may cause the predetermined information to be displayed until the meeting M1 ends or may delete the predetermined information from the display screen when a confirmation operation is received from the user. The notification processor 114 may also cause a countdown of the remaining time to be displayed.

According to the above configuration, the participants in the meeting M1 can be made aware that the start time of the next meeting M2 is imminent, so that the meeting M1 can be ended as scheduled. As a result, the subsequent meeting M2 can be started on schedule.

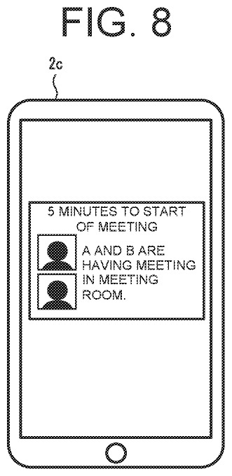

The notification processor 114 may also cause information indicating that the meeting M1 is being held (in session) in the meeting room R1 to be displayed on the user terminal 2c of the user C. FIG. 8 shows an example of the display screen of the user terminal 2c. As shown in FIG. 8, the notification processor 114 causes the remaining time to the end of the meeting M1 (“5 minutes”, here) and a message indicating that the users A, B are having a meeting in the meeting room R1 or the like to be displayed on the user terminal 2c. As a result, the user C can grasp a situation in the meeting room R1.

User Terminal 2

As shown in FIG. 2, the user terminal 2 includes a controller 21, a storage 22, an operation display 23, a reader 24, a communicator 25 and the like. The user terminal 2 is an information processor such as a smartphone, a personal computer (PC), a tablet terminal and the like.

The communicator 25 is a communicator which connects the user terminal 2 to the network N1 in a wired or wireless manner and executes data communication according to a predetermined communication protocol with other devices (the management server 1, for example) via the network N1. The user terminal 2 is also connected to meeting room equipment (the display 3, a microphone-speaker device, a camera and the like) via the communicator 25 by a wired LAN or a wireless LAN.

The reader 24 reads the communication tag Tg. For example, the reader 24 communicates with the communication tag Tg by NFC (near field communication) and reads the identification information (tag ID) of the communication tag Tg. As another embodiment, the reader 24 may be constituted by a camera and read information codes (such as two-dimensional codes) installed near the entrance/exit of the meeting room. In this case, the reader 24 reads the meeting room ID associated with the information code.

The operation display 23 is a user interface including a display such as a liquid-crystal display or an organic EL display, which displays various types of information and an operation acceptor such as a mouse, a keyboard, or a touch panel, which accepts an operation. The operation display 23 accepts, for example, operations of the user of the user terminal 2.

The storage 22 is a non-volatile storage such as an HDD, an SSD, or a flash memory, which stores various types of information. The storage 22 stores control programs such as a meeting support program to cause the controller 21 to execute meeting support processing (see FIG. 9) and the like described below. For example, the meeting support program is recorded in a computer-readable recording medium such as a CD or a DVD in a non-transitory manner, is read by a reader (not shown) such as a CD drive or a DVD drive included in the user terminal 2, and is stored in the storage 22. The meeting support program may be distributed from a cloud server and stored in the storage 22.

The controller 21 has control devices such as a CPU, a ROM, and a RAM. The CPU is a processor that executes various types of arithmetic processing. The ROM stores in advance control programs such as a BIOS and an OS that cause the CPU to execute various types of processing. The RAM stores various types of information and is used as a temporary storage memory (work area) for the various types of processing executed by the CPU. And the controller 21 controls the user terminal 2 by causing the CPU to execute various types of control programs stored in advance in the ROM or the storage 22.

Specifically, the controller 21 includes various processors such as a reading processor 211, a display processor 212 and the like. The controller 21 executes various types of processing in accordance with the control program in the CPU and functions as various types of processors described above. Moreover, some or all of the processors included in the controller 21 may be configured by an electronic circuit. The control program may be a program that causes a plurality of processors to function as the various types of processors described above.

The reading processor 211 transmits the identification information of the communication tag Tg read by the reader 24 to the management server 1. For example, when the user C arrives at the meeting room R1 and reads the communication tag Tg1 (see FIG. 1) by the user terminal 2c, the reading processor 211 of the user terminal 2c transmits the identification information of the communication tag Tg1 to the management server 1. The reading processor 211 may also transmit the location information corresponding to the identification information of communication tag Tg1 (meeting room ID, for example) to the management server 1.

The location acquisition processor 111 of the management server 1 acquires the identification information of the communication tag Tg1 from the user terminal 2c and then, acquires the location information of the user C (user terminal 2c) on the basis of the meeting room ID associated with the communication tag Tg1 (see FIG. 4).

The display processor 212 causes various types of information to be displayed on the operation display 23. For example, the display processor 212 causes a login screen of the meeting support application, a meeting information screen that displays meeting information, an operation screen that accepts operations to start, to end, or to extend a meeting, and a meeting screen that is displayed during a meeting after the meeting was started and the like to be displayed.

Moreover, the display processor 212 causes the predetermined information notified from the management server 1 to be displayed when a participant of the next meeting arrives at the meeting room during the meeting. For example, as shown in FIG. 6, the display processors 212 of the user terminals 2a, 2b cause the information notified from the management server 1 to be displayed on each of the user terminals 2a, 2b, when a participant (user C) of the next meeting M2 arrives at the meeting room R1 while the users A, B are having a meeting in the meeting room R1. Moreover, as shown in FIG. 8, for example, the display processor 212 of the user terminals 2c causes the information notified from the management server 1 to be displayed on the user terminal 2c, when the participant (user C) of the next meeting M2 arrives at the meeting room R1 while the users A, B are having a meeting in the meeting room R1.

In addition to the processing described above, the controller 21 causes the meeting support application to be executed. The controller 21 also starts the meeting support application and executes the login processing. The controller 21 also connects the user terminal 2 to the display 3, a microphone-speaker device, a camera and the like. When the user terminal 2 and the display 3 are connected, meeting materials, for example, are displayed on the display 3. Moreover, progress of the meeting, remaining time to the end of the meeting and the like are displayed on the display 3. The controller 21 may also cause the display screen of the user terminal 2 to be displayed on the display 3.

The controller 21 also accepts meeting end instructions from the user. When the controller 21 accepts a meeting end instruction from the user, it ends the meeting and logs the user off from the meeting support application.

Meeting Support Processing

With reference to FIG. 9, an example of a procedure of the meeting support processing executed in the meeting support system 100 will be described.

The present disclosure can be viewed as a disclosure of a meeting support method (an example of the meeting support method of the present disclosure) in which one or a plurality of steps included in the meeting support processing are executed. The one or a plurality of steps included in the meeting support processing described herein may be omitted as appropriate. In addition, an execution order of each step in the meeting support processing may be different as long as the same or similar operational effects are exerted.

Furthermore, a case in which the controller 11 of the management server 1 executes each step in the meeting support processing will be described here as an example, but in other embodiments, one or more processors may execute each step in the meeting support processing in a dispersed manner.

Here, a state in which, at the current time (“10:55”), the users A, B are having a meeting (“meeting M1”) in the meeting room R1 as shown in the example above (see FIG. 1 and FIG. 3), and the user C, who will participate in the next meeting M2 (meeting start time “11:00”) is waiting in front of the meeting room R1 will be described as an example.

First, at Step S1, the controller 11 acquires location information of the user (user terminal 2). For example, when the user C comes to the meeting room R1 to participate in the meeting M2 and holds the user terminal 2c over the communication tag Tg1, the user terminal 2c transmits the identification information of the user terminal 2c and the identification information of the communication tag Tg1 to the management server 1. When the controller 11 acquires, from the user terminal 2c, the identification information of the user terminal 2c and the identification information of the communication tag Tg1, it acquires the location information corresponding to the identification information of the communication tag Tg1 (meeting room ID of the meeting room R1, here).

Next, at Step S2, the controller 11 updates the user-information management table T3 (see FIG. 5). Here, the controller 11 registers the acquired location information (meeting room R1, for example) in the user-information management table T3.

Next, at Step S3, the controller 11 acquires the meeting schedule information. Specifically, when the user C holds the user terminal 2c over the communication tag Tg1 of the meeting room R1, the controller 11 identifies the user on the basis of the identification information of the user terminal 2c acquired from the user terminal 2c and acquires the meeting schedule information for the meeting in which the identified user is registered as a participant. Here, the controller 11 acquires the meeting schedule information for the meeting M2 in which the user C will participate. The controller 11 also acquires the meeting schedule information of the meeting room R1 corresponding to the acquired location information (the meeting schedule information of the meeting M1 currently being held in the meeting room R1, for example).

Next, at Step S4, the controller 11 determines whether the target meeting in which the user will participate is registered in the acquired meeting schedule information or not. If the target meeting in which the user will participate is registered in the meeting schedule information (S4: Yes), the controller 11 moves the processing to Step S5. On the other hand, if the target meeting in which the user will participate is not registered in the meeting schedule information (S4: No), the controller 11 ends the processing. Here, since the meeting M2 in which the user C will participate is registered in the meeting schedule information (S4: Yes), the controller 11 moves the processing to Step S5.

At Step S5, the controller 11 determines whether the user is a participant of the meeting or not. If the user is a participant of the meeting (S5: Yes), the controller 11 moves the processing to Step S6. On the other hand, if the user is not a participant of the meeting (S5: No), the controller 11 ends the processing. Here, since the user C is registered in the meeting schedule information as a participant of the meeting M2 (S5: Yes), the controller 11 moves the processing to Step S6.

At Step S6, the controller 11 notifies the meeting participants having the meeting of predetermined information. Here, since the meeting M1 is being held in the meeting room R1 (see FIG. 1), the controller 11 notifies the users A, B, who are participants of the meeting M1, of the predetermined information.

Specifically, the controller 11 causes information indicating that the user C is waiting outside the meeting room R1 to be displayed at least on any one of the user terminals 2a, 2b of the users A, B (see FIG. 6) and the display 3a (see FIG. 7) installed in the meeting room R1. The controller 11 also causes information about the end time of the meeting M1 of the users A, B to be displayed at least on any one of the user terminals 2a, 2b of the users A, B (see FIG. 6) and the display 3a (see FIG. 7).

After Step S6, the controller 11 ends the processing. The controller 11 executes the processing described above each time it acquires location information (information of the communication tag Tg) from the user terminal 2 of each user.

As described above, the meeting support system 100 according to this embodiment acquires the location information of the first user, acquires the meeting schedule information of the first user, determines whether the first meeting to be held in the first meeting room corresponding to the location information is registered in the meeting schedule information or not, and determines whether the first user is registered in the meeting schedule information as a participant of the first meeting or not. Then, when the first meeting is registered in the meeting schedule information and the first user is registered in the meeting schedule information as a participant of the first meeting, the meeting support system 100 notifies the participants of the second meeting currently being held in the first meeting room of the predetermined information.

As a result, when a previous meeting is being held in the meeting room to be used for the meeting, for example, it is possible to cause the participants in the meeting being held to recognize that the start time of the next meeting is approaching. This allows the meeting to end as scheduled and the next meeting to start as scheduled.

### OTHER EMBODIMENTS

The present disclosure is not limited to the above-described embodiment. Other embodiments of the present disclosure will be described below.

FIG. 10 shows that the users D, E, who are participants of the meeting M2 have entered the meeting room R2 (example of the second user of this disclosure). For example, when the user D holds the user terminal 2d over the communication tag Tg2 in the meeting room R2, the user terminal 2d transmits the identification information of the communication tag Tg2 to the management server 1. When the controller 11 of the management server 1 acquires the identification information of the communication tag Tg2 from the user terminal 2d, it checks usage status of the meeting room R2 on the basis of the meeting room ID (see FIG. 4) associated with the communication tag Tg2. When the meeting room R2 is vacant, the controller 11 notifies the user terminal 2d of the information indicating that the meeting room R2 is vacant. FIG. 11 shows an example of the display screen of the user terminal 2d. As shown in FIG. 11, the controller 11 causes a message indicating that the meeting room R2 is vacant, time to the start time of the meeting M2 and the like to be displayed on the user terminal 2d. When the user E holds the user terminal 2e over the communication tag Tg2 of the meeting room R2, the controller 11 presents display similar to that on the user terminal 2d (see FIG. 11).

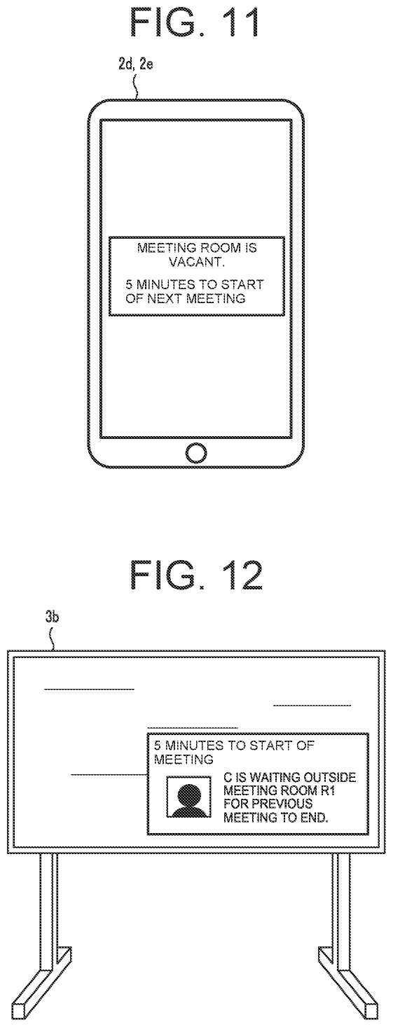

In addition, as shown in FIG. 12, the controller 11 causes the remaining time to the end of the meeting M1 being held in the meeting room R1 (here, “5 minutes”), a message indicating that the user C, who will participate in the meeting M2 in the meeting room R1, is waiting outside the meeting room R1 or the like to be displayed on the display 3b of the meeting room R2.

The controller 11 may also acquire the location information of a participant of a meeting when the participant performs a meeting start operation at the user terminal 2. For example, when the users D, E who entered the meeting room R2 log in the meeting support application at the user terminals 2d, 2e, the controller 11 updates the location information of the users D, E from “outside the meeting room” to “inside the meeting room”.

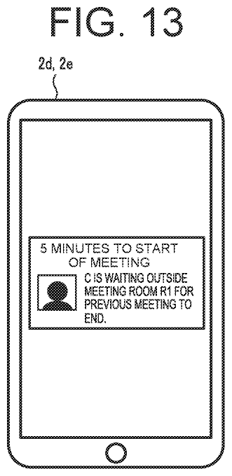

In addition, as shown in FIG. 13, the controller 11 causes the remaining time to the end of the meeting M1 being held in the meeting room R1 (here, “5 minutes”), a message indicating that the user C is waiting outside the meeting room R1 or the like to be displayed on each of the user terminals 2d, 2e.

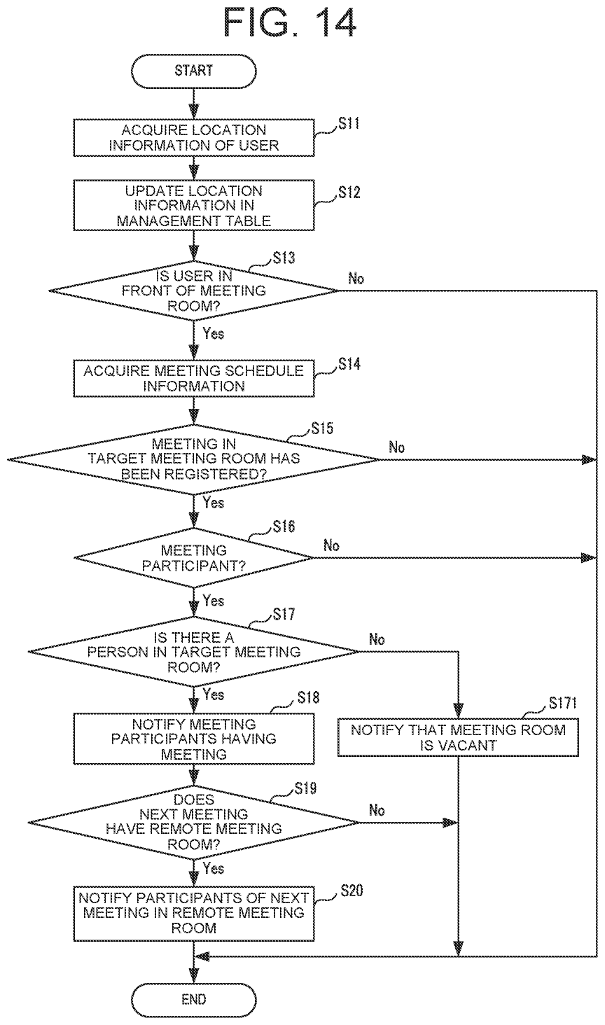

FIG. 14 is a flowchart showing an example of a procedure of the meeting support processing according to another embodiment. In the following, the same processing as the meeting support processing shown in FIG. 9 will be omitted or briefly described as appropriate.

At Step S11, the controller 11 acquires location information of the user (user terminal 2). Next, at Step S12, the controller 11 updates the user-information management table T3 (see FIG. 5).

Next, at Step S13, the controller 11 determines whether the user is in front of the meeting room or not. If the user is in front of the meeting room (S13: Yes), the controller 11 moves the processing to Step S14. If the user is not in front of the meeting room (S13: No), the controller 11 ends the processing. For example, the controller 11 determines whether the user is in front of the meeting room or inside the meeting room. Specifically, when a user logs in the meeting support application at the user terminal 2, selects the meeting room in which he/she is located, and gives an instruction to start a meeting, the controller 11 determines that the user is in the meeting room. In this case, the controller 11 registers the location information of the inside of the meeting room where the user is located in the user-information management table T3. Thus, the controller 11 may acquire the location information of a participant in a meeting when he/she performs a meeting start operation at the user terminal 2.

At Step S14, the controller 11 acquires the meeting schedule information (meeting schedule information of the meeting M2). The controller 11 also acquires the meeting schedule information of the meeting room R1 corresponding to the acquired location information (the meeting schedule information of the meeting M1 currently being held in the meeting room R1, for example).

Next, at Step S15, the controller 11 determines whether the target meeting in which the user will participate is registered in the acquired meeting schedule information or not. If the target meeting in which the user will participate is registered in the meeting schedule information (S15: Yes), the controller 11 moves the processing Step S16 On the other hand, if the target meeting in which the user will participate is not registered in the meeting schedule information (S15: No), the controller 11 ends the processing.

At Step S16, the controller 11 determines whether the user is a participant of the meeting or not. If the user is a participant of the meeting (S16: Yes), the controller 11 moves the processing to Step S17. On the other hand, if the user is not a participant of the meeting (S16: No), the controller 11 ends the processing.

At Step S17, the controller 11 determines whether there are people (meeting participants) in the target meeting room or not. If there are people in the meeting room (S17: Yes), that is, if a meeting is being held in the meeting room, the controller 11 moves the processing to Step S18. On the other hand, if there is not a person in the meeting room (S17: No), the controller 11 moves the processing to Step S171.

At Step S18, the controller 11 notifies the meeting participants having the meeting in the meeting room of predetermined information. For example, the controller 11 causes a message indicating that the user C is waiting outside the meeting room R1 or the like to be displayed on each of the user terminals 2a, 2b of the users A, B having a meeting in the meeting room R1 (see FIG. 6).

At Step S171, the controller 11 notifies information indicating that the meeting room is vacant. For example, the controller 11 causes a message indicating that the meeting room is vacant or the like to be displayed on each of the user terminals 2d, 2e of the users D, E, who will participate in the meeting in the meeting room R2 (see FIG. 11).

At Step S19, the controller 11 determines whether a remote meeting room is included in a meeting location for the next meeting or not. If a remote meeting room is included in the meeting location for the next meeting (S19: Yes), the controller 11 moves the processing to Step S20. On the other hand, if a remote meeting room is not included in the meeting location for the next meeting (S19: No), the controller 11 ends the processing.

At Step S20, the controller 11 notifies the participants of the next meeting in the remote meeting room of predetermined information. For example, the controller 11 causes a message indicating that the user C is waiting outside the meeting room R1 or the like to be displayed on each of the user terminals 2d, 2e of the users D, E, who will participate in the meeting M2 in the meeting room R2 (see FIG. 13). In addition, the controller 11 causes a message indicating that the user C is waiting outside the meeting room R1 or the like to be displayed on the display 3b installed in the meeting room R2 (see FIG. 12).

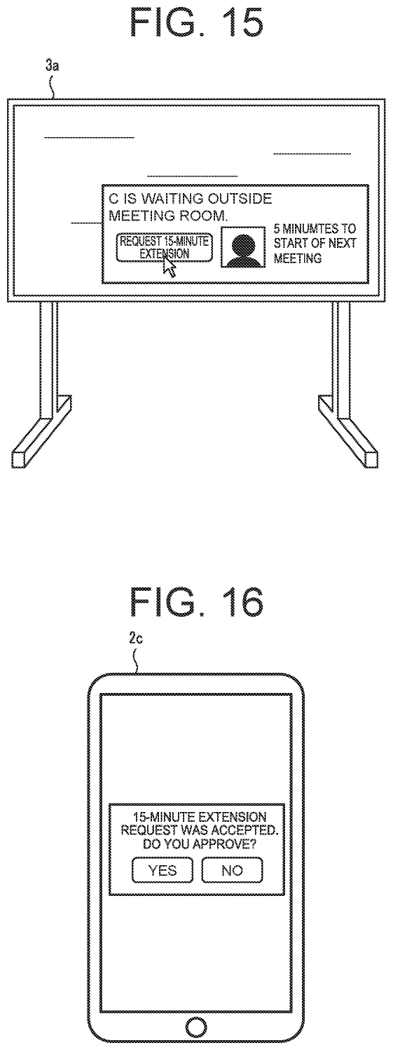

As another embodiment of the present disclosure, the meeting support system 100 may accept a request for an extension of a meeting from a user during the meeting. Specifically, as shown in FIG. 15, when the user C of the next meeting M2 is in front of the meeting room R1 during the meeting of the meeting M1, the controller 11 causes a message indicating that the user C is waiting outside the meeting room R1 to be displayed and moreover, causes an application button which accepts a request for an extension of the meeting M1 to be displayed on the message. When the users A, B press down the application button to apply for the extension of the meeting M1, the controller 11 (notification processor 114) notifies a message of an inquiry of availability of the extension to the user terminal 2c of the user C (See FIG. 16). The user C determines on the user terminal 2c whether the extension is approved or not for the request for extension. If the user C allows the extension, the controller 11 extends the scheduled end time of the meeting M1. For example, the controller 11 extends the scheduled end time of the meeting M1 only by a predetermined period of time (15 minutes). When the scheduled end time of the meeting M1 is extended, the controller 11 notifies information that the meeting M1 has been extended and the scheduled end time after the extension and the like to each of the user terminals 2c, 2d, 2e of the users C, D, E, who are participants of the next meeting M2.

As described above, when an application for an extension of the scheduled end time of the meeting M1 is made, the controller 11 (notification processor 114) notifies the user terminal 2 of the user of the meeting M2 of a message inquiring whether the extension is possible or not.

As another embodiment of the present disclosure, in a case where the time when the location information of the user C is acquired is in a period from a predetermined time before the scheduled start time of the meeting M2 to the scheduled start time, the controller 11 (notification processor 114) may notify information indicating that the user C is waiting outside the meeting room R1. Moreover, in a case where the time when the location information of user C is acquired is earlier than the predetermined time before the scheduled start time of the meeting M2, the controller 11 may notify warning information to the user terminal 2c of the user C.

For example, if the time when the user C arrives at the meeting room R1 and holds the user terminal 2c over the communication tag Tg1 is “10:55”, it is within the predetermined time (10 minutes, for example) to the scheduled start time of the meeting M2 in which the user C will participate, that is, “11:00”. In this case, as shown in FIG. 6, the controller 11 causes the predetermined information (that the user C is waiting outside the meeting room R1) to be displayed on the user terminals 2a, 2b of the users A, B.

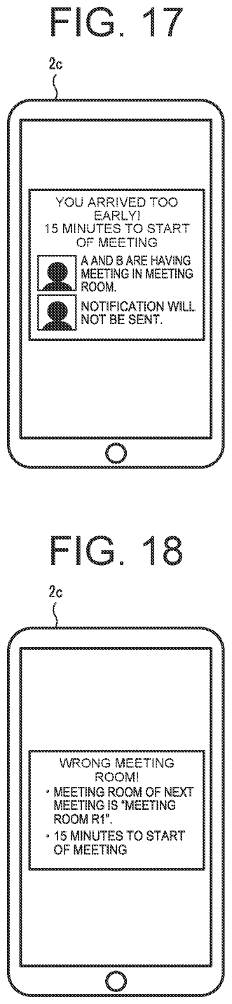

On the other hand, for example, if the time when the user C arrives at the meeting room R1 and holds the user terminal 2c over the communication tag Tg1 is “10:45”, it is earlier than the predetermined time (10 minutes, for example) before the scheduled start time of the meeting M2 in which the user C will participate, that is, “11:00”. In this case, as shown in FIG. 17, the controller 11 causes a message (warning information) indicating that there is time to the scheduled start time of the meeting M2 (that it is too early to come to the meeting room R1) or the like to be displayed on the user terminal 2c of the user C. The controller 11 may also notify messages that the users A, B are having a meeting in the meeting room R1 and that the predetermined information (that the user C is waiting outside the meeting room R1) is not to be notified to the users A, B or the like.

As another embodiment of the present disclosure, when the user C has mistaken the meeting room, the controller 11 (notification processor 114) may also cause a message indicating that the meeting room is wrong to be displayed on the user terminal 2c as shown in FIG. 18. For example, when the user C comes to a meeting room R3 (not shown) and holds the user terminal 2c over the communication tag Tg, the location information of the user C (meeting room R3) is acquired. When the acquired location information is different from the meeting room R1 of the meeting M2 in which the user C will participate, the controller 11 causes a message reporting to the user terminal 2c that the meeting room is wrong, information on the correct meeting room (in this case, the meeting room R1), time to the scheduled start time of the meeting M2 and the like to be displayed on the user terminal 2c. As a result, the meeting participant can immediately grasp that the meeting room is wrong.

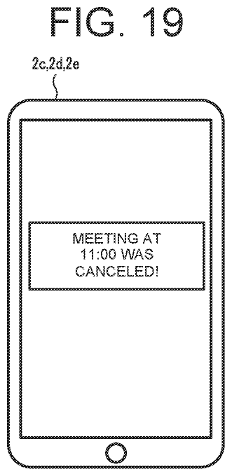

As another embodiment of the present disclosure, when the meeting M2 in which the users C, D, E are to participate is canceled, the controller 11 (notification processor 114) may cause a message indicating that the meeting M2 was canceled to be displayed on the user terminals 2c, 2d, 2e of the users C, D, E, respectively, as shown in FIG. 19. As a result, the meeting participant can reliably grasp that the meeting was canceled.

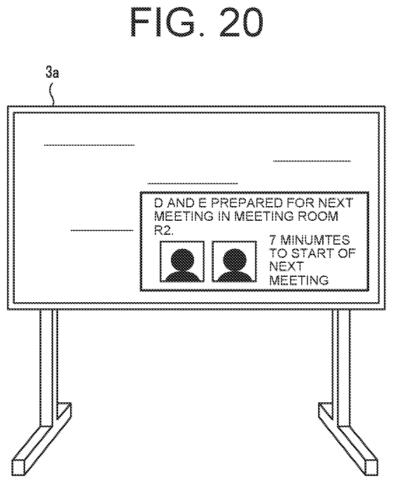

As another embodiment of the present disclosure, in a case where the users A, B are having a meeting in the meeting room R1 as shown in FIG. 10, the controller 11 (notification processor 114) may notify the users A, B of the predetermined information when the users D, E, who are participants of the next meeting M2, entered the meeting room R2 and have completed preparation for the next meeting M2. For example, when the users D, E log in the meeting support application, the controller 11, as shown in FIG. 20, causes a message indicating that preparation for the meeting M2 is completed to be displayed on the display 3a in the meeting room R1. As a result, the meeting M1 can be ended as scheduled, and the next meeting M2 can be started as scheduled.

As described above, the meeting support system of the present disclosure may be configured by the management server 1 and the user terminal 2 as shown in FIG. 2, by the single management server 1, or by the single user terminal 2, as shown in FIG. 2.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A meeting support system which supports a meeting in which a plurality of users participate, comprising:
a first acquisition circuit which acquires location information of a first user;
a second acquisition circuit which acquires meeting schedule information of the first user;
a first determination circuit which determines whether a first meeting to be held in a first meeting room corresponding to the location information is registered in the meeting schedule information or not;
a second determination circuit which determines whether the first user is registered in the meeting schedule information as a participant of the first meeting or not, and
a notification circuit which notifies participants of a second meeting currently being held in the first meeting room of predetermined information when the first meeting is registered in the meeting schedule information and the first user is registered in the meeting schedule information as a participant of the first meeting.

2. The meeting support system according to claim 1, wherein
the notification circuit causes information indicating that the first user is waiting outside the first meeting room to be displayed at least on any one of user terminals of the participants in the second meeting and a first display installed in the first meeting room.

3. The meeting support system according to claim 1, wherein
the notification circuit causes information on end time of the second meeting to be displayed at least on any one of user terminals of the participants in the second meeting and a first display installed in the first meeting room.

4. The meeting support system according to claim 1, wherein
the notification circuit further causes information indicating that the second meeting is being held in the first meeting room to be displayed on a user terminal of the first user.

5. The meeting support system according to claim 1, wherein
in a case where time when the location information is acquired is in a period from a predetermined time before a scheduled start time of the first meeting to the scheduled start time, the notification circuit notifies information indicating that the first user is waiting outside the first meeting room.

6. The meeting support system according to claim 1, wherein
when an application for an extension of a scheduled end time of the second meeting is made, the notification circuit notifies a user terminal of the first user of a message inquiring whether the extension is possible or not.

7. The meeting support system according to claim 1, wherein
in a case where time when the location information is acquired is earlier than predetermined time before a scheduled start time of the first meeting, the notification circuit notifies warning information to a user terminal of the first user.

8. The meeting support system according to claim 1, wherein
when a second user who participates in the first meeting in a second meeting room is registered in the meeting schedule information, the notification circuit causes information indicating that the first user is waiting outside the first meeting room to be displayed at least on either one of a user terminal of the second user and a second display installed in the second meeting room.

9. The meeting support system according to claim 1, wherein
when a user terminal of the first user reads out a reading target installed in association with the first meeting room, the first acquisition circuit acquires location information of the first user.

10. The meeting support system according to claim 1, wherein
when a participant of a meeting performs a meeting start operation on a user terminal, the first acquisition circuit acquires location information of the participant.

11. A meeting support method which supports a meeting in which a plurality of users participate, wherein
one or a plurality of processors execute:
acquiring location information of a first user;
acquiring meeting schedule information of the first user;
determining whether a first meeting to be held in a first meeting room corresponding to the location information is registered in the meeting schedule information or not;
determining whether the first user is registered in the meeting schedule information as a participant of the first meeting or not, and
when the first meeting is registered in the meeting schedule information and the first user is registered in the meeting schedule information as a participant of the first meeting, notifying participants of a second meeting currently being held in the first meeting room of predetermined information.

12. A non-transitory computer-readable recording medium which records a meeting support program supporting a meeting in which a plurality of users participate and causes one or a plurality of processors to execute:
acquiring location information of a first user;
acquiring meeting schedule information of the first user;
determining whether a first meeting to be held in a first meeting room corresponding to the location information is registered in the meeting schedule information or not;
determining whether the first user is registered in the meeting schedule information as a participant of the first meeting or not, and
when the first meeting is registered in the meeting schedule information and the first user is registered in the meeting schedule information as a participant of the first meeting, notifying participants of a second meeting currently being held in the first meeting room of predetermined information.
